(19) United States
(12) Patent Application Publication
(10) Pub. No.: US 2004/0091208 A1
(43) Pub. Date: May 13, 2004

(54) Planar optical wave-guide with dielectric mirrors

(76) Inventor: Yutaka Doi, Columbia, MD (US)

Correspondence Address: David J. Zoetewey, Rutan & Tucker, LLP, 14th Floor, 611 Anton Blvd., Costa Mesa, CA, 92626, US

(21) Appl. No.: 10/293,423

(22) Filed: Nov. 12, 2002

(51) Int. Cl. G02B 6/26; G02B 6/10

(52) U.S. Cl. 385/31; 385/129

(57) ABSTRACT

Waveguides comprising dielectric mirrors and dielectric cladding preferably formed by modifying a portion of a dielectric layer to adjust its index of refraction relative to other portions of the dielectric layer.

### FIELD OF THE INVENTION

The field of the invention is optical board waveguides.

### BACKGROUND OF THE INVENTION

An optical board, as the term is used herein, is a board (possibly a printed wiring board) or other support structure that comprises one or more optical waveguides. An optical waveguide is a structure that “guides” a light wave by constraining it to travel along a certain desired path. A waveguide traps light by surrounding a guiding region, called the core, with a material called the cladding, where the core is made from a transparent or translucent material with higher index of refraction than the cladding. Cores typically comprise polymeric and non-polymeric materials, and a waveguide having a non-polymeric core may be referred to as a non-polymeric waveguide.

In some instances, the optical waveguides of an optical board will include one or more surface traces, such traces frequently comprising an optical resin deposited on a substrate to form a ridge waveguide. In some instances an optical board may comprise a plurality of parallel traces.

### SUMMARY OF THE INVENTION

The present invention is directed to waveguides comprising dielectric mirrors and dielectric cladding. In preferred embodiments a portion of a dielectric layer is modified to adjust its index of refraction such that portions of the layer intended to act as a waveguide have a higher index of refraction that the portions of the layer surrounding the waveguide.

The need to surround a core by cladding or to otherwise plate surfaces to form mirrors is eliminated so long as the index of refraction of the core is at least the square root of two (1.414) times the index of refraction of any surrounding materials.

Eliminating the need for cladding layers allows the use of waveguide formation methods that do not provide access to all of the surfaces surrounding any waveguides being formed.

Being able to form a waveguide without accessing all of the surfaces surrounding the waveguide facilitates the use of methods in which a layer of material is formed and subsequently treated such that portions of the layer have a higher index of refraction than surrounding portions of the layer, thereby forming waveguides within the layer.

In preferred embodiments, achieving the desired difference in index of refraction can be obtained by excavating portions of an optical layer to form grooves which are filled with another optical material with a higher refractive index.

In alternative embodiments, achieving the desired difference in index of refraction can be achieved by subjecting portions of a dielectric layer to ultra-violet (UV) radiation. In some instances, a portion of the dielectric layer intended to be the core of a waveguide will be subjected to UV radiation in order to raise its index of refraction. In other instances, the area surrounding the waveguide portion to UV radiation in order to lower its index of refraction.

Eliminating the use of metallic plating to form mirrors and cladding reduces costs by reducing or eliminating the need for metals for plating and risk by reducing or eliminating the chance of metal particles plugging the waveguide.

In preferred embodiments, elongated waveguides having a rectangular cross section are terminated at one or both ends by surfaces angled at forty-five degrees relative to the central axis of the waveguide, with the angled surfaces and all other “reflective” surfaces being formed from a dielectric material having a lower index of refraction than the core of the waveguide.

Waveguides comprising non-polymeric cores such as those made from soda lime and borosilicate glass formulations are preferred.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1A is a front view of an optical board embodying the invention.

FIG. 1B is a side view of the optical board of FIG. 1A.

### DETAILED DESCRIPTION

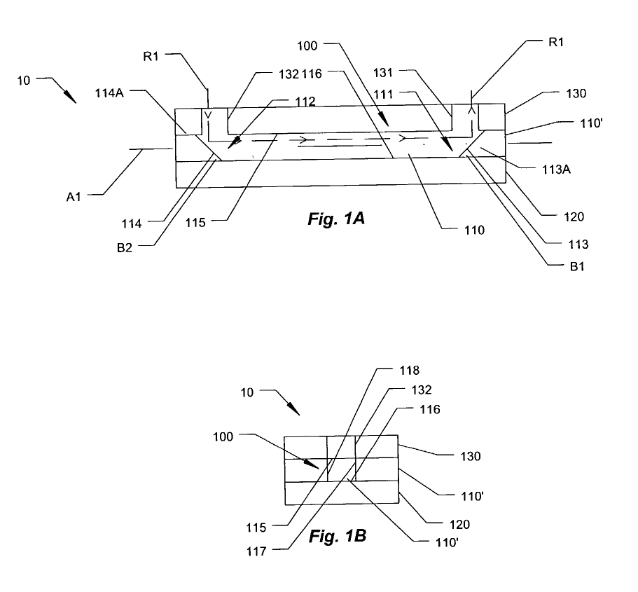

In FIGS. 1A and 1B, optical board 10 comprises a waveguide 100 as part of waveguide layer 110′, a substrate 120, and an encapsulating layer 130. Waveguide 100 comprises an elongated segment/core 110 that is symmetrical around a central axis A1 passing through the length of the segment 110. Ends 111 and 112 of segment 110 each comprise an angled surface 113 or 114 that is neither perpendicular to, nor parallel with, the central axis A1 of the segment 110, but instead forms an angle B1 or B2 with axis A1. In some embodiments, the segment may be curved rather than linear in which case the “axis” viewed from the top will be curved horizontally. Angled surfaces 113 and 114 are not mirrored in that they are not are plated with a coating having a lower index of refraction than portions of layer 110′ that are adjacent to core 110 but made of a different material. Moreover, top wall 115 and bottom wall 116 of core 110 are not mirrored, nor are side walls 117 and 118 of core 110. As can be seen, surfaces 113 and 114 are tilted at a forty-five degree angle relative to axis A1, and are perpendicular to each other. Waveguide 100 has a rectangular cross section formed by parallel walls 115 and 116, and parallel walls 117 and 118 that are perpendicular to walls 115 and 116. Optical vias 131 and 132 permit light to pass into and/or out of waveguide 100 through covering/encapsulating layer 130. As an example, light ray R1 is provided to illustrate a possible path for light to follow while entering, passing through, and exiting waveguide 100.

The need to surround a core by cladding or to otherwise plate surfaces to form mirrors is eliminated so long as the index of refraction of the core is at least the square root of two (1.414) times the index of refraction of any surrounding materials. As such, core 110 preferably comprises a transparent or translucent material such as tantalum oxide, whose index of refraction is 2.1˜2.2 in comparison with glass whose index of refraction is about 1.5. Less preferred embodiments may utilize other materials such as glass.

In some instances layer 110′ may comprise a transparent or translucent material that can be formed into a layer and subsequently treated to modify the index of refraction of portions of the layer so as to form optical waveguides in the layer. It is contemplated that other materials and treatment methods may be used to form layer 110′ and core 110 as well.

The waveguide of FIG. 1 comprises dielectric mirrors and dielectric cladding. Surfaces 113, 114, 117 and 118 are part of layer 110′, and are formed from the same material as 110′ but a different material than core 110. Core 110 has a higher index of refraction than that of the portions of the layer 110′ surrounding the core 110. As such, there is no need to plate any of surfaces 113, 114, 116, 117, and 118.

It is possible that in some embodiments, surfaces 113, 114, 117 and 118 will be part of layer 110′, and are formed from the same material as 110′ and core 110, but will mark the boundary between a portion of the layer (core 110) subjected ultra violet processing and portions subjected to less or no ultra violet processing. As such, core 110 was modified to adjust its index of refraction such that that portion of the layer has a higher index of refraction than that of the portions of the layer 110′ surrounding the core 110. In such embodiments, since core 110 is formed directly from layer 110′, there is no need to expose or plate any of surfaces 113, 114, 116, 117, and 118.

Eliminating the use of metallic plating to form mirrors and cladding reduces costs by reducing or eliminating the need for metals for plating and risk by reducing or eliminating the chance of metal particles plugging the waveguide.

Core 110 may comprise any cross-sectional shape although preferred embodiments will be symmetrical around central axis A1. As such, circular, square, and rectangular shapes are all preferred shapes with rectangular being the most preferred. Non-polymeric cores such as those made from soda lime and borosilicate glass formulations are preferred.

Although waveguide 100 as shown comprises a single segment 110, other embodiments may utilize multiple segments some of which may not be coplanar with other segments.

It is contemplated that waveguides as disclosed herein may advantageously used in numerous applications, but are particularly suited for use in optical back planes and optical printed circuit/wiring boards.

Substrate 120, although ideally formed from one or more layers and providing structural support to layer 110′, may be formed from any suitable material whose index of refraction is lower than 1/1.414 of that of the core. Similarly, encapsulating layer 130 may be formed form one or more layers and may be formed from any suitable material whose index of refraction is lower than 1/1.414 of that of the core.

It is contemplated that preferred waveguide embodiments will comprise one or more of the following features: at least one dielectric mirror; a core portion of a layer of transparent or translucent material at least partially enclosed by a cladding portion of the same layer of transparent or translucent material wherein either the cladding or core portions have been treated to cause the core portion to have an index of refraction at least 1.4 times that of the cladding portion; and at least one elongated segment symmetrical around a central axis passing through the length of the segment, the elongated segment having at least one end comprising a dielectric mirror comprising an angled surface that is neither perpendicular to, nor parallel with, the central axis of the segment, wherein the angled surface is a non-plated dielectric.

Methods of forming preferred waveguides may comprise any combination of the following steps: providing a transparent or translucent material and processing portions of the transparent or translucent material to raise or lower the index of refraction of those portions of the material; raising or lower the index of refraction by a factor of at least 1.4; exposing portions of a transparent or translucent material to ultra violet radiation; encapsulating the waveguide layer by laminating a third layer on or to a waveguide layer opposite a substrate layer, and possibly forming at least one optical via in such a third layer, the optical via being positioned adjacent to an end of the waveguide.

Thus, specific embodiments and applications of optical waveguides have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A non-polymeric waveguide comprising at least one dielectric mirrors.

2. The waveguide of claim 1 wherein the waveguide comprises a core portion of a layer of transparent or translucent material at least partially enclosed by a cladding portion of the same layer of transparent or translucent material wherein either the cladding or core portions have been treated to cause the core portion to have an index of refraction at least 1.4 times that of the cladding portion.

3. The waveguide of claim 2 wherein the treatment comprises subjecting the core portion to ultra violet radiation so as to raise the index of refraction of the core portion.

4. The waveguide of claim 1 wherein each waveguide comprises at least one elongated segment symmetrical around a central axis passing through the length of the segment, the elongated segment having at least one end comprising a dielectric mirror comprising an angled surface that is neither perpendicular to, nor parallel with, the central axis of the segment, wherein the angled surface is a non-plated dielectric.

5. The waveguide of claim wherein the waveguide comprises a soda lime or borosilicate glass core.

6. A method of forming a non-polymeric waveguide comprising providing a transparent or translucent layer and processing portions of the transparent or translucent material to raise or lower the index of refraction of those portions of the material.

7. The method of claim 6 wherein the index of refraction is raised or lowered by a factor of at least 1.4.

8. The method of claim 7 wherein processing comprises exposing the portions of the material to ultra violet radiation.

9. The method of claim 8 wherein the portions exposed to ultra violet radiation comprise the core of the waveguide and results in the core of the wave guide having an index of refraction at least 1.4 times that of adjacent, non-core portions of the material.

10. The method of claim 9 wherein the transparent or translucent material is a waveguide layer supported by a substrate.

11. The method of claim 10 further comprising encapsulating the waveguide layer by depositing or laminating a third layer opposite the substrate.

12. The method of claim 11 further comprising forming at least one optical via in the third layer, the optical via being positioned adjacent to an end of the waveguide.

13. The method of claim 12 wherein the formed waveguide comprises at least one elongated segment symmetrical around a central axis passing through the length of the segment, the elongated segment having at least one end comprising a dielectric mirror comprising an angled surface that is neither perpendicular to, nor parallel with, the central axis of the segment, wherein the angled surface is a non-plated dielectric.
